(19) United States
(12) Patent Application Publication
(10) Pub. No.: US 2005/0108757 A1
(43) Pub. Date: May 19, 2005

(54) Method for updating software of a target device using an extended identifier in digital broadcasting

(75) Inventors: Kwang-Kee Lee, Seoul (KR); Glenn A. Adams, Cambridge, MA (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/989,252

(22) Filed: Nov. 17, 2004

Related U.S. Application Data
(60) Provisional application No. 60/520,379, filed on Nov. 17, 2003.

(30) Foreign Application Priority Data
Jan. 9, 2004 (KR) 10-2004-0001607

(51) Int. Cl. H04N 7/173; H04N 5/445; H04N 5/217; H04N 5/21

(52) U.S. Cl. 725/50; 725/51; 725/132; 725/140; 713/100

(57) ABSTRACT

A method for updating software of a digital broadcasting receiving apparatus using an extended identifier, including broadcasting information having a version of an extended identifier and an extended software of a receiving device targeted for software updating using a data service announcement, and transmitting the software to the receiving apparatus having the extended identifier when the software transmission condition is met. Software update services can be provided by distinguishing receiving apparatuses in a unique manner using an UUID, with little or no modification of the conventional data broadcasting standards.

This invention is based on and claims priorities of Korean Patent Application No. 10-2004-0001607 filed on Jan. 9, 2004 in the Korean Intellectual Property Office and U.S. Provisional Patent Application No. 60/520,379 filed on Nov. 17, 2003 in the United States Patent and Trademark Office, the disclosures of which are incorporated herein by reference.

### BACKGROUND OF THE INVENTION

1. Field of Invention

The present invention relates to a method for upgrading software of a target device in digital broadcasting. More particularly, the present invention relates to a method for updating software of a target device whose software is subject to updating, the target device being one of several target devices.

2. Description of the Related Art

Recently there has been expanded interest in digital broadcasting. Digital broadcasting literally refers to a mode of broadcasting in which videos, audios, data and so on are processed and converted into digital signals and then transmitted in a transmission mode of digital signals, which is distinguished from a conventional analog broadcasting. Digital processing refers to conversion of analog signals into digital signals composed of zero (0) and one (1) using high-advanced digital technologies, wherein the converted signals are compressed together with other information and then transmitted in the digital transmission mode. The transmitted signals are restored to videos and/or audios as originally identified in a receiving device (that is, target device) called a set-top box.

Digital signals are advantageous in that they are generally resistant to noise, need less power of transmission, can use a technique of error correction and have less degradation due to transmission, copying and accumulation, in comparison to analog signals. In addition, since digital signals can use a compression algorithm such as a motion picture expert group (MPEG), it is possible to compress video and audio signals sharply to thereby reduce the amount of information. Besides, it is easy to retrieve, process and edit information and to utilize a large scale integration (LSI) technique. Digital broadcasting enjoys the advantages that digital signals have as described above, and thus, it is also superior to conventional analog television in several aspects, such as strong resistance to noise, efficient transmission of information and so on. The digital broadcasting that is currently being commercialized, or is in the process of being commercialized, supports high-definition broadcasting which has picture quality that is over two times clearer than in the conventional analog TV set. In terms of sound quality, stereophonic sound of 5.1 channel is supported, thereby allowing a user to hear live sound as if he/she is at a concert hall. The aspect ratio of the screen is 16:9, (i.e., a wide screen is adopted at the same ratio of a theater screen), thereby making it possible to watch a movie in a full mode when watching the movie at home. A digital TV can also receive data from or transmit data to a variety of home electric appliances including a digital versatile disk (DVD) player, a digital camcorder, a digital VCR and the like, all of which process signals in a digital mode, similar to a personal computer (PC), by means of a series interface. Digital broadcasting services using bidirectional networks, which have recently been ready to be provided to users, can provide a variety of bidirectional services with added values, for example, home shopping and home banking as well as Internet searches.

FIG. 1 is a functional block diagram illustrating a configuration of an interactive digital broadcasting system.

The digital broadcasting system generally comprises a digital broadcasting service provider 100 and a plurality of receiving devices (target devices) 200 receiving digital broadcasts supplied by the digital broadcasting service provider 100. The digital broadcasting service provider 100 may refer to broadcasting stations which transmit digital broadcasting signals. The digital broadcasting service provider 100 may broadcast content as internally produced on its own and/or broadcasting contents provided by a content provider (not shown). The digital broadcasting service provider 100 may provide unidirectional services through broadcasting media available only for unidirectional data transmission to the target device 200 as well as analog bidirectional services through bidirectional networks. When a user uses one of the bidirectional media, the user may request the digital broadcasting service provider 100 to provide him/her with video on demand (VOD) services by means of the target device 200 for bidirectional digital broadcasting or place an order to the provider 100 to purchase any items an actor/actress is wearing, such as clothes, accessories, while he/she is watching the TV.

Currently, there are by and large two modes of digital broadcasting transmission: ATSC (Advanced Television Systems Committee) mode and DVB (Digital Video Broadcasting) mode. ATSC mode has been proposed by the Advanced Television Systems Committee to develop and study digital TV standards in the United States and DVB mode has been established by the Europe Broadcasting Union (EBU).

The DVB mode uses orthogonal frequency division multiplexing (OFDM), which may be modulated to differential quadrature phase shift keying (DQPSK) or n-quadrature amplitude modulation (n-QAM). The DVB broadcasting system is basically comprised of a source coding and multiplexing unit, a channel coding and modulating unit, a transmission medium, a demodulating and decoding unit and a display unit. The source coding and multiplexing unit uses MPEG-2 to compress digital images and sounds to a desired transmission speed and thereby reduce the bandwidth required. The channel coding and modulating unit adds any residual data to MPEG-2 data coded for channel coding in order to cope with any error which may be caused in the course of signal transmission. When the channel coding is finished, the channel-coded signals are demodulated as appropriate depending upon the state of a transmission medium. There are a variety of transmission media according to the broadcasting types, satellite, cable or terrestrial broadcasting, etc. The demodulating and decoding unit restores baseband signals from radio frequency (RF) signals transmitted through the transmission medium. The display unit displays the restored signals.

The ATSC mode has been used as a terrestrial transmission standard defining the speed of transporting bitstream content, and transmitting digital data at 6 MHz RF channel, adopting 19.4 Mbps as the official speed of bitstream. ATSC system employs RF modulation mode of 8 vestigial side band (VSB) using multiple picture format, digital audio/video compression, packetization and a single carrier.

Data broadcasting is available through digital broadcast. Currently the transmission standard of terrestrial digital TV in Korea's data broadcasting is ATSC-A/90 and the service standard thereof is ATSC-DTV application software environment (ATSC-DASE). The transmission standard of digital satellite broadcast is ETSI-EN 301 192 established by European Telecommunication Standards Institute (ETSI) and the service standard thereof is DVB multimedia home platform (DVB-MHP). In the case of digital cable broadcasting, the service standard thereof is open cable application platform (OCAP). OCAP is based on MHP and can thus communicate content with MHP. Content exchange between ATSC-DASE and DVB-MHP is currently not possible, and thus, researches with respect thereto are under study.

In ATSC data broadcasting, the transmission protocol follows standards of ATSC-A/90, which can be obtained at www.atsc.org/standards/a 90-with-att.pdf, which is incorporated by reference. After data are encapsulated by the protocol, the data are multiplexed in the structure of MPEG-2 transport stream and then transmitted. The service protocol follows the ATSC-DATABASE specification, and makers of receiving apparatuses are required to provide hardware platforms, operation systems, and device drivers that are compatible with protocols using the ATSC-DATABASE specification. Currently the makers of receiving apparatuses can update software for receiving apparatuses under specific models. However, it is not sufficient to distinguish each and all receiving apparatuses employing a number of models manufactured by a large number of makers, only with a total 16 bits of the model fields. In addition, receiving apparatuses employing the same model are likely to be supplied with different versions of software depending upon the time when they were manufactured. Further, there may be a difficulty in distinguishing the version of software exactly and specifically, resorting only to the 16 bit version field.

### SUMMARY OF THE INVENTION

Considering the troubles and difficulties described above, the present invention is conceived. According to an aspect of the present invention, there is provided an extended model field to distinguish digital broadcasting receiving apparatuses and a service method for updating software thereof by defining an extended version field to more exactly distinguish versions of software for updating and distinguishing a receiving apparatus subject to updating by use of the extended model field and the extended version field.

Consistent with an exemplary embodiment of the present invention, there is provided a method for updating software of a digital receiving apparatus comprising broadcasting information including a version of an extended identifier and an extended software of a receiving device targeted for software updating using a data service announcement, and transmitting the software to the receiving apparatus having the extended identifier when the software transmission condition is met.

Preferably, the extended identifier comprises a universally unique identifier (UUID). Also the version of the extended software may employ at least two or more sub-versions, and the version system has three layers such as a major version, a minor version and a micro version, each of which is represented with 16 bits.

The data service announcement may include information on the time for software update, and the software transmission condition is met when the time for software update approaches. The time information for the software update included in the data service announcement may comprise two cases: one case where the update is made within a predetermined period of time and the other case where the update is made after a predetermined period of time has passed.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram schematically illustrating a configuration of an interactive digital broadcasting system;

FIG. 2 is a diagram illustrating a process of updating software according to an exemplary embodiment of the present invention;

FIG. 3 is a diagram illustrating a process of updating software according to another exemplary embodiment of the present invention;

FIG. 4 is a table illustrating structures of compatibility descriptors of Digital Storage Media Command and Control of ATSC data broadcast standards (A/90);

FIG. 5 is a table illustrating structures of extended model subdescriptors according to an exemplary embodiment of the present invention;

FIG. 6 is a table illustrating structures of extended version subdescriptors according to an exemplary embodiment of the present invention; and

FIG. 7 is a table illustrating structures of software updating information descriptors according to an exemplary embodiment of the present invention.

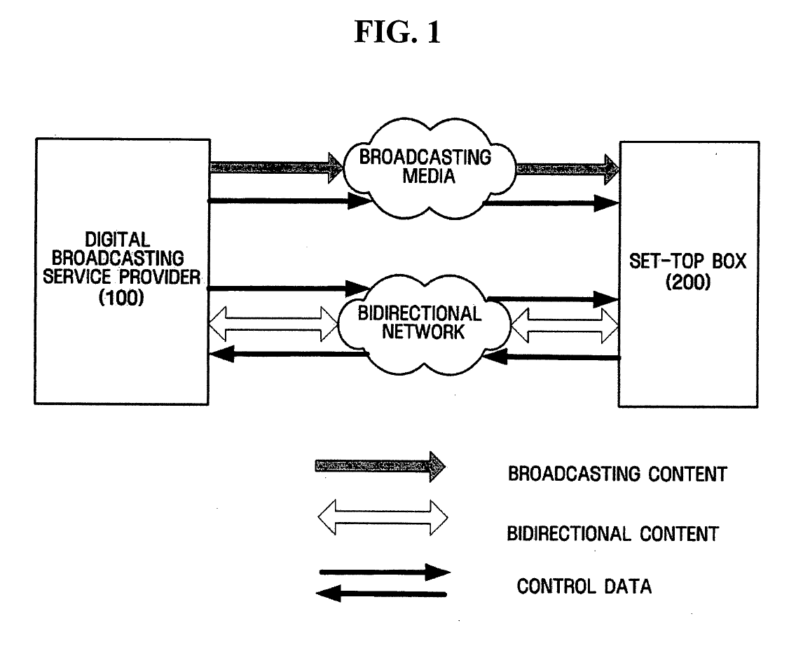

### DETAILED DESCRIPTION OF THE INVENTION

Hereinafter, the present invention, will be described in more detail with reference to the accompanying drawings.

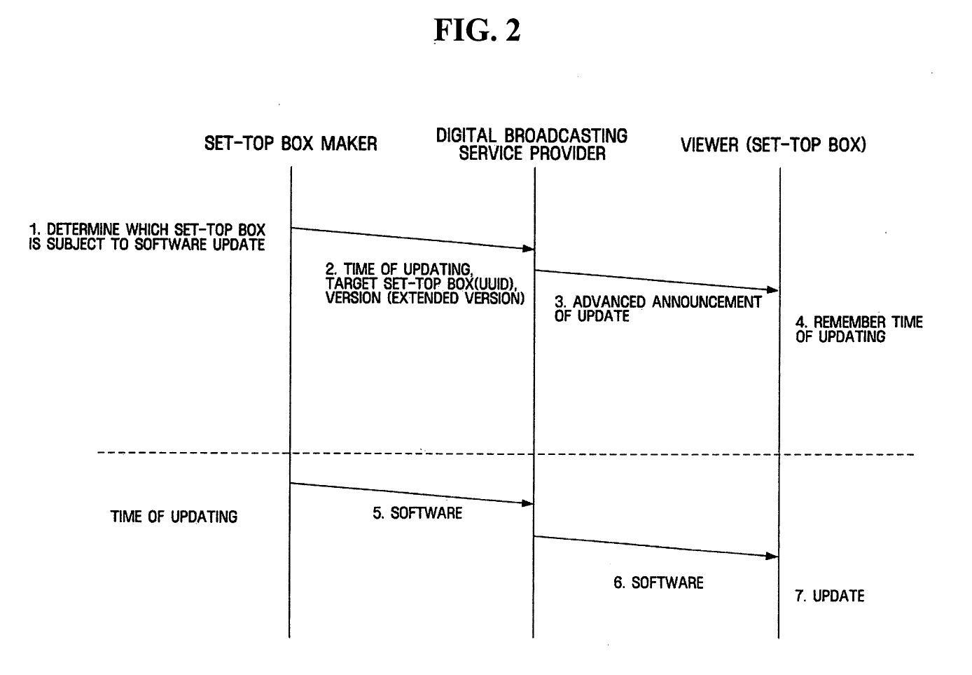

FIG. 2 is a diagram illustrating a process of updating software according to an exemplary embodiment of the present invention.

A set-top box maker determines whether software of a set-top box is subject to receiving an updating service (hereinafter referred to as “a target set-top box”). Where there is a need to update software of set-top boxes under a certain model or to update software of set-top boxes during a particular period of time, the set-top box maker ascertains a proper identifier of a concerned set-top box so as to distinguish the target set-top box from other set-top boxes. When the set-top box maker produces its set-top boxes, it allocates a proper identifier to each of the respective devices or models. In the exemplary embodiments of the present invention, the proper identifiers employ UUIDs (Universally Unique Identifiers) proposed by Microsoft Corporation. UUID is a term to refer to a proper number generated by a program so as to allocate a proper identity to such an entity as a Microsoft Word™ document. Most conventional programming languages have used names as identifiers, which should be unique in the relevant technology area. To secure the uniqueness, a GUID (Global Unique Identifier) and UUID have been proposed, and both terms have essentially the same meaning. GUID and UUID are both structures with 128 bit size. If they are generated by a UunidCreateo function, they are only allowed to generate a unique identifier. This uniqueness is global and has no relevance to time and place. Thus, the set-top box maker can make its set-top boxes having their proper identifiers distinguished from the set-top boxes produced by other makers, by using UUID.

The set-top box maker determines which set-top box is subject to receiving its software update. When determined, the maker provides the time of updating, the UUID of the target set-top box, and the current version of software to a digital broadcasting service provider. The digital broadcasting service provider gives an advance notice to broadcast the update service so as to allow viewers to learn information about the time of updating, the UUID of the target set-top box, and the current version of software. When the UUID included in the advance notice broadcasted is identical to that of the target set-top box and the version of software to be updated is higher than its own version, the target set-top box memorizes the time of updating and arranges for updating when the updating time has come.

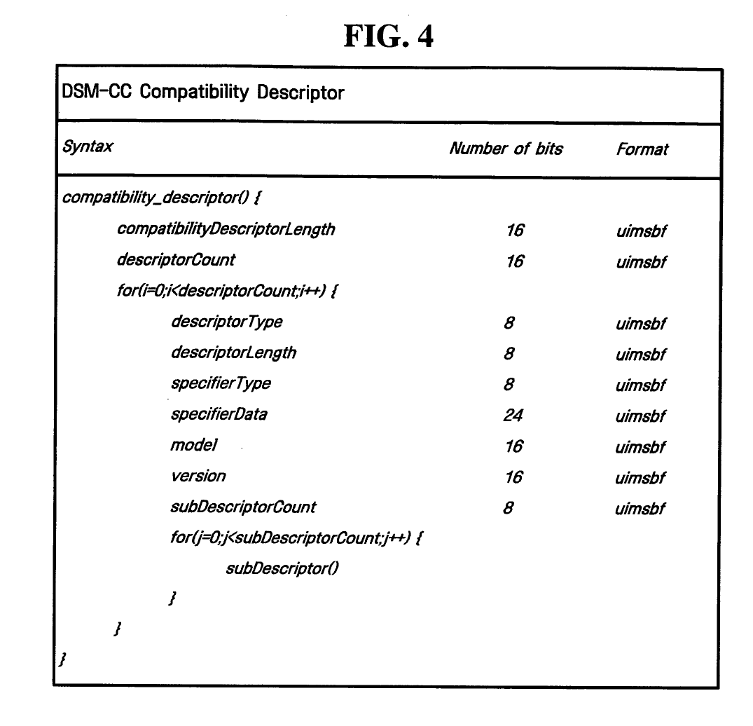

When the updating time comes, the set-top box maker supplies the software to be updated to the digital broadcasting service provider and the provider broadcasts the software. The set-top box having received the broadcast software updates its own software. Announcement, signaling, and encapsulation will be described with respect to FIGS. 4 through 7.

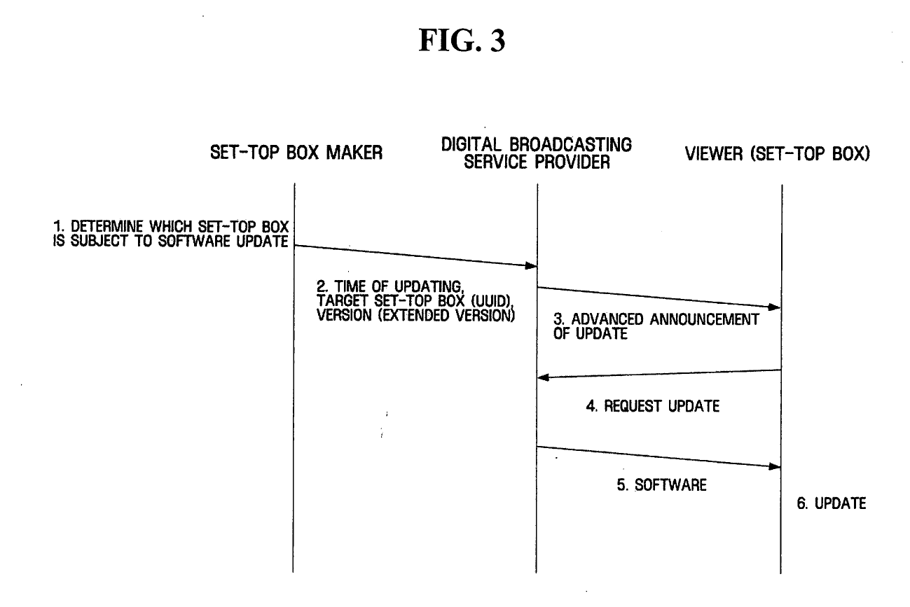

FIG. 3 is a diagram illustrating a process of updating software according to another exemplary embodiment of the present invention.

In FIG. 3, software updating is based on a bidirectional network. A set-top box maker determines which set-top box is targeted to update its software and ascertains the UUID of the target set-top box. Subsequently, the set-top box maker provides the digital broadcasting service provider with software, UUID of the target set-top box, and the version of software. The provider broadcasts an advance notice for updating to allow users to learn which set-top box is targeted for software updating and the version of software. The set-top box having received the updating notice determines whether its UUID is identical to the UUID identified in the update notice and whether the version of software is newer than its own. When the notice for software updating is directed to the set-top box that received the notice, this target set-top box requests the digital broadcasting service provider to update its software and the digital broadcasting service provider having received such a request transmits the software to be updated to the target set-top box. The target set-top box that receives the software, updates its own software. When the digital broadcasting service provider gives an advance notice for updating as shown in FIG. 3, the URL of the software targeted for updating may be sent at the same time. In this case, the set-top box may receive the concerned software directly at the received URL to thereby update the software.

FIG. 4 is a table illustrating structures of compatibility descriptors of Digital Storage Media Command and Control of ATSC data broadcast standards (A/90). In FIG. 4, the term “uimsbf” is an abbreviation of “unsigned integer most significant bit first.”

Among compatibility descriptors, the field “compatibilityDescriptorLength” refers to a field having 16 bits, indicating the total length of a descriptor including the field of “descriptorCount,” excluding the length of “compatibilityDescriptorLength.” The “descriptorCount” field comprises a 16 bit field, specifying the number of descriptors. The field “descriptorType” comprises an 8 bit field, which is used to distinguish types of hardware or software. The field “descriptorLength” comprises an 8 bit field, indicating the total length of the descriptors, excluding the descriptors “descriptorType” and “descriptorLength.”

The field “specifierType” comprises an 8 bit field, which is used to distinguish formats of the field of “specifierData.” The field “specifierData” comprises the 24 bit field, distinguishing an organization in a unique manner. The value allocated to this field is dependent upon the “specifierType” field.

The field “model” comprises a 16 bit field, used to distinguish various models defined by an organization. In an exemplary embodiment of the present invention, the “model” field is extended so as to use a UUID of 128 bits, which will be described later. The field “version” comprises a 16 bit field, used to distinguish different versions of the models defined by the organization. In an exemplary embodiment of the present invention, the version field is extended and the version is specified and distinguished, which will be described later.

The field “subDescriptorCount” comprises an 8 bit field, representing the number of subDescriptors.

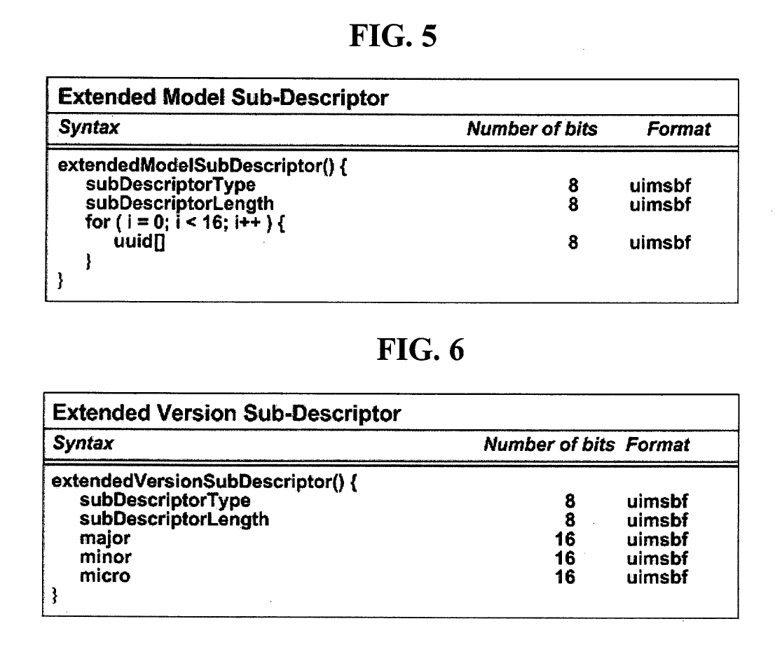

In the exemplary embodiments of the present invention, (1) the “descriptorcount” field has the value of “0x002” to indicate that it has two descriptors, (2) the “descriptorType” field has the vale of 0x01” to indicate the system hardware, (3) the “specifierType” field has the value of 0x01 value to indicate OUI of IEEE (Institute of Electrical and Electronics Engineers), (4) the first descriptor of the “specifierData” field has to have a unique value allocated by the IEEE for the makers of terminals covered by software update, (5) the model and version fields of the first descriptor have to be defined by the maker of a concerned terminal, and they are used for the software update, except for the cases of 0x0000 and 0xFFFF, (6) the “extendedModelSubDescribor” field according to the present invention should be defined as in FIG. 5 and be included in the descriptor when a value of the model field of the first descriptor is 0x0000, (7) the software update may be applied to all the models of a specified maker if the model field value of the first descriptor is 0xFFFF, (8) the “extendedVersionSubDescribor” field according to the present invention should be defined as in FIG. 6 and be included in the descriptor when a value of the model field of the first descriptor is 0x0000, (9) the software update may be applied to all the models of a specified maker if the version field value of the first descriptor is 0xFFFF, (10) the “subDescriptorCount” field of the first descriptor may be larger than 2, in the case in which the terminal ignores all subDescriptors when the “subDescriptorType” field is not specified as 0x01 or 0x02, (11) the “descriptorType” field of the second descriptor may have the value of 0x02, indicating that it is the system software, and (12) the software components to be updated, rather than hardware components, of the terminal are specified under the above items (3) through (10), which will apply to the second descriptor except for the maker, model and version to be used.

FIG. 5 is a table illustrating structures of extended model subdescriptors according to an exemplary embodiment of the present invention.

An extended model subdescriptor employs UUID allocated by the maker to specify hardware or software model. In the exemplary embodiments of the present invention, since the UUID is used, it may have a much larger space than the 16 bit model field of DSM-CC compatibility descriptor, to distinguish hardware or software.

The value “subDescriptorType” indicates a type of the subdescriptor. The type of the subdescriptor has the value of 0x01. The “subDescriptorLength” has a value to indicate the number of bits within the subdescriptor after this field. The “uuido” is a field to specify the UUID determined by the maker, which distinguishes a unique model of hardware or software.

FIG. 6 is a table illustrating structures of extended version subdescriptors according to an exemplary embodiment of the present invention.

The extended version subdescriptor is used to specify the version of hardware or software, having the numbers of main version, sub version and micro version as allocated by the maker. According to an exemplary embodiment of the present invention, the extended version subdescriptor provides a mechanism more extendible so as to distinguish a version of hardware units or a version of software components.

The “subDescriptorType” field indicates a type of a subdescriptor. The value to indicate the type of the subdescriptor is 0x02. The “subDescriptorLength” field indicates the number of bits within the subdescriptor following this field. The “minor” specifies the number of a subversion and “micro” specifies the number of a micro version. When each version has the value of 0xFFFF, it is used to indicate all versions of each version.

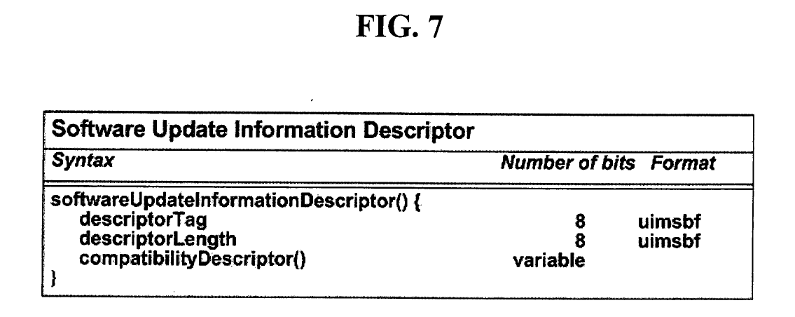

FIG. 7 is a table illustrating structures of software update information descriptors according to an exemplary embodiment of the present invention.

Basically, software update data service employs a data service announcement as defined by ATSC-A/90 in order to provide notification of the software update. Limited use thereof will be described with reference to FIG. 7. A descriptor describing software update information is used to provide information about a software update in the context of a software update data service announcement. The structures therefor will be considered below.

The “descriptorTag” field indicates a type of the descriptor, having the constant value of 8 bits. The “descriptorLength” is a field used to indicate the number of bits following this field in this descriptor, having the value of 8 bits. The “compatibilityDescriptor” is a field used to specify the compatibility descriptor described in FIGS. 4 to 6.

The software update service needs to be scheduled for broadcasting. Where broadcasting is to made within 16 days (384 hours) from a current period, for example, the broadcasting is advised using a data event table (DET) specified by ATSC-A/90. To be specific, (1) descriptor( ) comprises one or more software update information descriptors as an internal descriptor loop structure of an entry of data_event_table_section( ) which is a structure for the software update data service announcement. When one and more software update information descriptors are in the same entry of the structure data_event_table_section( ), the above-described software update information descriptors are not to be identical.

When a schedule is made to broadcast a software update data service within 16 days following the current period, the broadcasting is advised using a long term service table (Long-Term Service Table: LTST) specified by ATSC-A/90. (2) the descriptor( ) comprises one or more software update information descriptors as an internal descriptor loop structure of an entry of long_term_service_table( ) which is a structure for the software update data service announcement. When one and more software update information descriptors are in the same entry of the structure long_term_service_table( ), the above-described software update information descriptors are not to be identical.

The software update service is signaled using the service description framework defined according to ATSC-A/90. The following shows limitations applied to an entry of each application of the data service table (DST), the data service table explaining software updates for the data applications.

(1) The field “compatibilityDescriptor( ) is a structure used to specify a compatibility descriptor described, for example, in FIGS. 4 to 6.

(2) The field “app_id_byte_length” has a value of 0x0012.

(3) The field “app_id_description” has a value of 0x0001.

(4) The field “app_id_byte( )” is a UUID coded in a binary mode, the UUID being unique with respect to the parameter space <deviceManufacturer, deviceModel, deviceVersion, softwareComponent, softwareComponentVersion>. These parameters are determined by the content of the compatibility descriptor.

(5) The field “tap_count” is larger than 0.

(6) The field “protocol_encapsulation” of each tap entry has the value of 0x0D (An asynchronous carousel scenario of DSM-CC download protocol).

(7) The field “action_type” of each tap entry has the value of 0x00 (runtime data).

(8) The field “resource_location” of each tap entry has the value of 0 (association tags within Program Map Table (PMT)).

(9) The field “tap_id” field of each tap entry has a unique value within the context of a single software update application.

(10) The field “use” of each tap entry has the value of 0x0000.

(11) The field “association_tag” of each tap entry has the same value as the association tag associated with a program elementary stream encapsulating the software update payload.

(12) The field “selector_length” of “selector( )” indicates that the structure of each tap has the value of 0, 4, 6 or 8.

(13) The field “selector_type” of “selector( )” has the values of 0x0101, 0x0107 or 0x0108 when the field “selector_length” has the value of 0, 4, 6 or 8.

(14) The field “tap_info_length” of each tap entry should not be 0. If the field of “tap-info-length” is 0, a terminal device ignores descriptors immediately following the tap entry that is not known.

(15) The field “app_info_length” should not be 0. If the field “app_info_length” is 0, a terminal device ignores descriptors immediately following the tap entry not known.

(16) The field “app_data_length” should not be 0. If the field “app_data_length” is 0, a terminal device ignores the field “app_data_byte( ) immediately following this field and it does not determine the nonstandard meaning with respect to the field.

The following indicates limitations applied to “data_service_table_bytes( )”, which relates to the structure of the data service table section signaled.

(17) The field “service_info_length” should not be 0. If “service_info_length” is 0, a terminal device ignores descriptors immediately following the tap entry that is not known.

(18) The field “service+private_data_length” should not be 0. If “service+private_data_length” is 0, a terminal device ignores the field “service_private_data_byte( ) immediately following this field and it does not determine the nonstandard meaning with respect to the field.

The software update payload is encapsulated into one or more modules as defined in Chapter 7 of DSM-CC, User-to-Network Download. Single and double level control structures are all permitted. Modules and constructions to encapsulate the software update payload will be defined by individual manufacturers.

According to the present invention, software update services can be provided by distinguishing receiving apparatuses in a unique manner using an UUID, with little or no modification of the conventional data broadcasting standards. Besides, the version information of software can be subdivided differently from the conventional digital broadcasting.

Although the present invention has been described in connection with the exemplary embodiments thereof shown in the accompanying drawings, the drawings are mere examples of the present invention. It can also be understood by those skilled in the art that various changes, modifications and equivalents thereof can be made thereto. Accordingly, the true technical scope of the present invention should be defined by the appended claims.

1. A method for updating software of a digital broadcasting receiving apparatus using an extended identifier, comprising:
broadcasting information including a version of an extended identifier and an extended software of a receiving device targeted for software updating using a data service announcement; and
transmitting the software to the receiving apparatus having the extended identifier when a software transmission condition is met.

2. The method as claimed in claim 1, wherein the extended identifier comprises a universally unique identifier (UUID).

3. The method as claimed in claim 1, wherein the version of the extended software employs at least two sub-versions.

4. The method as claimed in claim 2, wherein the version of the extended software employs at least two sub-versions.

5. The method as claimed in claim 3, wherein the sub-versions have at least three layers including at least a major version, a minor version and a micro version, each of which is represented with 16 bits.

6. The method as claimed in claim 4, wherein the sub-versions have at least three layers including at least a major version, a minor version and a micro version, each of which is represented with 16 bits.

7. The method as claimed in claim 1, wherein the data service announcement includes information on a time for a software update, and the software transmission condition is met when the time for software update approaches.

8. The method as claimed in claim 2, wherein the data service announcement includes information on a time for a software update, and the software transmission condition is met when the time for software update approaches.

9. The method as claimed in claim 7, wherein the time information for the software update included in the data service announcement comprises information related to at least one of two cases: one case in which the update is made within a predetermined period of time and another case in which the update is made after a predetermined period of time has passed.

10. The method as claimed in claim 8, wherein the time information for the software update included in the data service announcement comprises information related to at least one of two cases: one case in which the update is made within a predetermined period of time and another case in which the update is made after a predetermined period of time has passed.

11. The method as claimed in claim 1, wherein the software is signaled along with the information including the extended identifier and the software version using a service description framework.

12. The method as claimed in claim 2, wherein the software is signaled along with the information including the extended identifier and the software version using use of a service description framework.

13. A computer readable recording medium for recording a computer readable program to perform a method for updating software of a digital broadcasting receiving apparatus using an extended identifier, said method comprising:
broadcasting information including a version of an extended identifier and an extended software of a receiving device targeted for software updating using a data service announcement; and
transmitting the software to the receiving apparatus having the extended identifier when a software transmission condition is met.

14. The computer readable recording medium as claimed in claim 13, wherein the extended identifier comprises a universally unique identifier (UUID).
